(19) United States
(12) Patent Application Publication
(10) Pub. No.: US 2008/0238065 A1
(43) Pub. Date: Oct. 2, 2008

(54) ROLL CAGE ASSEMBLY

(76) Inventors: Richard D. Hart, Nashua, NH (US); Brian T. Hart, Bedford, MA (US); Arthur Berube, Hampstead, NH (US)

Correspondence Address: HOLLAND & KNIGHT LLP, 10 ST. JAMES AVENUE, 11th Floor, BOSTON, MA, 02116-3889, US

(21) Appl. No.: 11/972,736

(22) Filed: Jan. 11, 2008

Related U.S. Application Data
(60) Provisional application No. 60/885,782, filed on Jan. 19, 2007.

(51) Int. Cl. B60R 21/13

(52) U.S. Cl. 280/756

(57) ABSTRACT

A roll cage assembly, for use on a vehicle, includes one or more structural components. At least one roll cage displacement assembly is coupled to the one or more structural components and the vehicle. The at least one roll cage displacement assembly is configured to allow for displacement of the one or more structural components with respect to the vehicle.

### CROSS-REFERENCE TO RELATED APPLICATION

This application claims the benefit of U.S. provisional patent application Ser. No. 60/885,782, filed 19 Jan. 2007, the entire disclosure of which is incorporated herein by reference.

### TECHNICAL FIELD

This disclosure relates to roll cage assemblies and, more particularly, to quick-release roll cage assemblies that facilitate maintenance of the vehicles to which they are attached.

### BACKGROUND

Roll cage assemblies are often used to protect the occupants and/or components of a vehicle in the event of e.g., a rollover condition or an accident. Typically, roll cage assemblies are structural components that are rigidly attached to the vehicle.

In order to facilitate such rigid connection to the vehicle, roll cage assemblies are often bolted and/or welded to the vehicle. Unfortunately, a roll cage assembly may make it difficult to maintain the vehicle, as it may complicate the process of accessing the various serviceable components within the vehicle. Further, due to the manner in which the roll cage assembly is rigidly connected to the vehicle, the roll cage assembly may be quite difficult to remove from the vehicle.

### SUMMARY OF THE DISCLOSURE

In one implementation, a roll cage assembly, for use on a vehicle, includes one or more structural components. At least one roll cage displacement assembly is coupled to the one or more structural components and the vehicle. The at least one roll cage displacement assembly is configured to allow for displacement of the one or more structural components with respect to the vehicle.

One or more of the following features may also be included. The at least one roll cage displacement assembly may include one or more pivoting assemblies for allowing at least a portion of the one or more structural components to pivot with respect to the vehicle. The pivoting assembly may include at least one hinge assembly.

The roll cage may further include one or more armored panel assemblies coupled to at least one of the one or more structural components and configured to protect the vehicle from attack. The one or more armored panel assemblies may be constructed of a material chosen from the group consisting of: plate steel; Kevlar; and reactive armor material. The roll cage assembly may further include one or more protective panel assemblies coupled to at least one of the one or more structural components and configured to shield one or more devices included within the vehicle. The one or more protective panel assemblies may be constructed of a material chosen from the group consisting of: steel metal; plate steel; and plastic. The vehicle may be an unmanned vehicle, such as a law enforcement/military unmanned vehicle.

The at least one roll cage displacement assembly may include one or more toolless mounting assemblies for releasably coupling at least a portion of the one or more structural components to the vehicle. The one or more toolless mounting assemblies may include at least one pin assembly.

The one or more structural components may form a first roll cage assembly portion and a second roll cage assembly portion. The at least one roll cage displacement assembly may include a first roll cage displacement assembly coupled to the first roll cage assembly portion and the vehicle. The first roll cage displacement assembly may be configured to allow for displacement of the first roll cage assembly portion with respect to the vehicle. The at least one roll cage displacement assembly may include a second roll cage displacement assembly coupled to the second roll cage assembly portion and the vehicle. The second roll cage displacement assembly may be configured to allow for displacement of the second roll cage assembly portion with respect to the vehicle.

In another implementation, a roll cage assembly, for use on a vehicle, includes one or more structural components. At least one pivoting assembly allows at least a portion of the one or more structural components to pivot with respect to the vehicle.

One or more of the following features may also be included. The one or more structural components may form a first roll cage assembly portion and a second roll cage assembly portion. The at least one pivoting assembly may include a first pivoting assembly coupled to the first roll cage assembly portion and the vehicle. The first pivoting assembly may be configured to allow for displacement of the first roll cage assembly portion with respect to the vehicle. The at least one pivoting assembly may include a second pivoting assembly coupled to the second roll cage assembly portion and the vehicle. The second pivoting assembly may be configured to allow for displacement of the second roll cage assembly portion with respect to the vehicle.

In another implementation, a roll cage assembly, for use on an unmanned vehicle, includes a first roll cage assembly portion, and a second roll cage assembly portion. A first pivoting assembly, which is coupled to the first roll cage assembly portion and the unmanned vehicle, is configured to allow for displacement of the first roll cage assembly portion with respect to the unmanned vehicle. A second pivoting assembly, which is coupled to the second roll cage assembly portion and the vehicle, is configured to allow for displacement of the second roll cage assembly portion with respect to the unmanned vehicle.

One or more of the following features may also be included. The roll cage assembly may include one or more armored panel assemblies coupled to at least one of the first and second roll cage assembly portions and configured to protect the vehicle from attack. The one or more armored panel assemblies may be constructed of a material chosen from the group consisting of: plate steel; Kevlar; and reactive armor material. The unmanned vehicle may be a law enforcement/military unmanned vehicle.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a first isometric view of a roll cage assembly; and

FIG. 2 is a second isometric view of the roll cage assembly of FIG. 1.

### DETAILED DESCRIPTION OF THE PREFERRED EMBODIMENTS

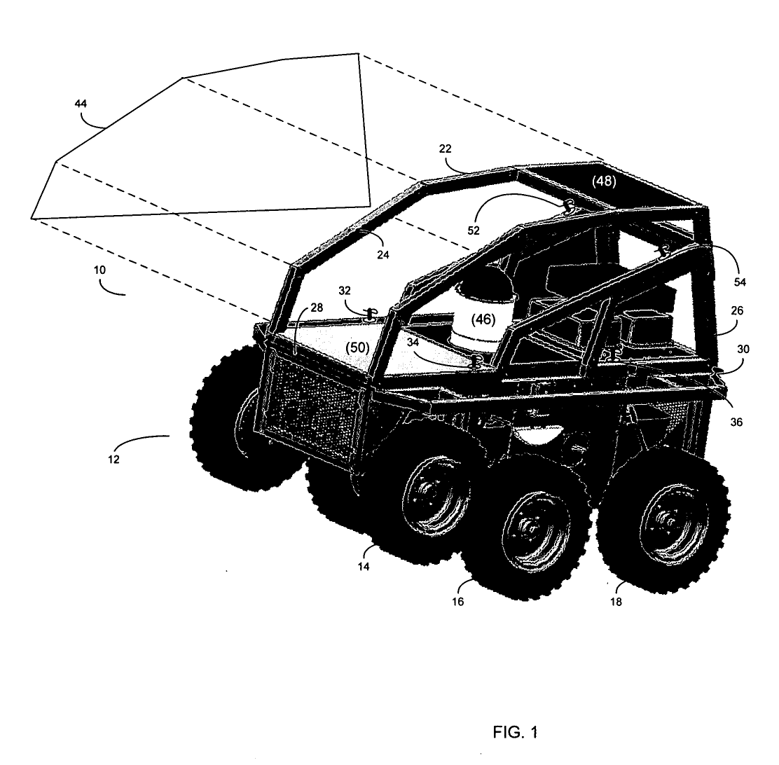

Referring to FIG. 1, there is shown roll cage assembly 10 installed on vehicle 12. Vehicle 12 may be a manned or unmanned vehicle for on or off road use. Examples of vehicle 12 may include, but are not limited to: dune buggies; all terrain vehicles; motorcycles; remotely-controlled vehicles, manned/unmanned military vehicles, manned/unmanned law enforcement vehicles, manned/unmanned patrol vehicles, manned/unmanned security vehicles, and manned/unmanned surveillance vehicles.

Vehicle 12 may include a plurality of drive axle assemblies. For example, in the embodiment shown in FIG. 1, vehicle 12 is shown to include three drive axle assemblies and is configured in a skid-steer arrangement (i.e., a vehicle that steers by rotating the wheels on one side of the vehicle at a different rate then the wheels on the other side of the vehicle. However, the number and type of wheel assemblies may be varied depending on the particular type of vehicle and the intended use of the vehicle. As discussed above, vehicle 12 may be an unmanned vehicle and, therefore, may be controlled via a remote transceiver 20 capable of providing control signals to and receiving data signals from vehicle 12.

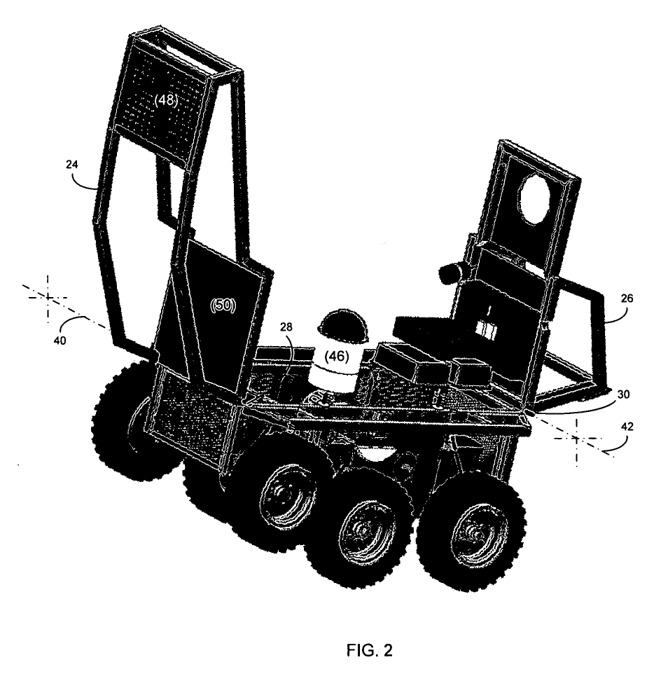

Referring also to FIG. 2, roll cage assembly 10 may include one or more structural components (e.g., structural component 22) that are rigidly assembled to form one or more roll cage assembly portions 24, 26. Examples of the structural components include, but are not limited to: square tube assemblies; round tube assemblies; and rectangular tube assemblies, which may be constructed of various materials (e.g., mild steel, and chromium-molybdenum steel).

Roll cage assembly 10 may include one or more roll cage displacement assemblies 28, 30, 32, 34, 36, each of which may be coupled to the one or more structural components and the vehicle. Each of the roll cage displacement assemblies 28, 30, 32, 34, 36 may be configured to allow for displacement of the one or more structural components (and, therefore, the one or more roll cage assembly portions 24, 26) with respect to vehicle 12, thus allowing access to the various devices (e.g., electric motors, batteries, controllers, transceiver circuitry, etc.) included within vehicle 12.

One or more of the roll cage displacement assemblies 28, 30, 32, 34, 36 may include one or more pivoting assemblies that allow at least a portion of the structural components to pivot with respect to vehicle 12. For example and in the embodiment shown in FIGS. 1 & 2, roll cage displacement assembly 28 is shown to be a hinge assembly that allows roll cage assembly portion 24 to pivot about axis 40. Further, roll cage displacement assembly 30 is shown to be a hinge assembly that allows roll cage assembly portion 26 to pivot about axis 42.

Roll cage assembly 10 may include one or more armored panel assemblies (e.g., armored panel 44) coupled to one or more of the structural components (e.g., structural component 24). The armored panel assemblies may be configured to protect vehicle 12 from attack. Accordingly, the armored panel assemblies may be positioned about the periphery of vehicle 12 to protect the sensitive/vulnerable devices (e.g., laser sensor 46) positioned within vehicle 12. The armored panel assemblies may be constructed of a material strong enough to provide the required level of protection, such as: plate steel; Kevlar; and reactive armor material.

Roll cage assembly 10 may include one or more protective panel assemblies (e.g., protective panel assemblies 48, 50) coupled one or more of the structural components (structural component 24). The protective panel assemblies may be configured to shield devices (e.g., electric motors, batteries, controllers, transceiver circuitry, etc.) included within vehicle 12 from e.g., mud, snow, and rain. The protective panel assemblies may be constructed of various materials, such as steel metal; plate steel; and plastic.

One or more of the roll cage displacement assemblies 28, 30, 32, 34, 36 may include one or more toolless mounting assemblies for releasably coupling at least a portion of the one or more structural components to the vehicle. For example and in the embodiment shown in FIGS. 1 & 2, roll cage displacement assemblies 32, 34 are shown to be pin assemblies configured to releasably couple roll cage assembly portion 24 to vehicle 12. Further, roll cage displacement assembly 36 is shown to be a pin assembly configured to releasably couple roll cage assembly portion 26 to vehicle 12. Additionally, roll cage assembly 10 may include one or more pin assemblies 52, 54 for e.g., releasably coupling roll cage assembly portion 24 to roll cage assembly portion 26, thus maintaining roll cage assembly 10 (which includes roll cage assembly portion 24 to roll cage assembly portion 26) in a “closed” position. While toolless mounting assemblies are shown to be pin assemblies, other configurations are possible and are considered to be within the scope of this disclosure. For example, an alternative embodiment of the toolless mounting assembly may include, but is not limited to, a bolt and wing nut assembly.

While roll cage assembly 10 is described above as including one or more pivoting assemblies that allow at least a portion of the structural components of roll cage assembly 10 to pivot with respect to vehicle 12, other configurations are possible and are considered to be within the scope of this disclosure. For example, all roll cage displacement assemblies may be toolless mounting assemblies for releasably coupling at least a portion of the one or more structural components to the vehicle. Therefore, the entire roll cage assembly 10 may be releasably coupled to vehicle 12. Accordingly, roll cage assembly 10 may be a single or multi-piece roll cage assembly that is releasably coupled to vehicle 10 using e.g., pin assemblies. Upon removal of these pin assemblies, the entire roll cage assembly 10 (or a portion thereof) may be removed from vehicle 10, thus allowing for access to the various devices (e.g., electric motors, batteries, controllers, transceiver circuitry, etc.) included within vehicle 12.

A number of implementations have been described. Nevertheless, it will be understood that various modifications may be made. Accordingly, other implementations are within the scope of the following claims.

What is claimed is:

1. A roll cage assembly for use on a vehicle, the roll cage assembly comprising:
one or more structural components; and
at least one roll cage displacement assembly coupled to the one or more structural components and the vehicle, the at least one roll cage displacement assembly being configured to allow for displacement of the one or more structural components with respect to the vehicle.

2. The roll cage assembly of claim 1 wherein the at least one roll cage displacement assembly includes one or more pivoting assemblies for allowing at least a portion of the one or more structural components to pivot with respect to the vehicle.

3. The roll cage assembly of claim 2 wherein the pivoting assembly includes at least one hinge assembly.

4. The roll cage assembly of claim 1 further comprising:
one or more armored panel assemblies coupled to at least one of the one or more structural components and configured to protect the vehicle from attack.

5. The roll cage assembly of claim 4 wherein the one or more armored panel assemblies are constructed of a material chosen from the group consisting of: plate steel; Kevlar; and reactive armor material.

6. The roll cage assembly of claim 1 further comprising:
one or more protective panel assemblies coupled to at least one of the one or more structural components and configured to shield one or more components included within the vehicle.

7. The roll cage assembly of claim 6 wherein the one or more protective panel assemblies are constructed of a material chosen from the group consisting of: steel metal; plate steel; and plastic.

8. The roll cage assembly of claim 1 wherein the vehicle is an unmanned vehicle.

9. The roll cage assembly of claim 8 wherein the unmanned vehicle is a law enforcement/military unmanned vehicle.

10. The roll cage assembly of claim 1 wherein the at least one roll cage displacement assembly includes one or more toolless mounting assemblies for releasably coupling at least a portion of the one or more structural components to the vehicle.

11. The roll cage assembly of claim 1 wherein the one or more toolless mounting assemblies includes at least one pin assembly.

12. The roll cage assembly of claim 1 wherein the one or more structural components form a first roll cage assembly portion and a second roll cage assembly portion.

13. The roll cage assembly of claim 12 wherein the at least one roll cage displacement assembly includes:
a first roll cage displacement assembly coupled to the first roll cage assembly portion and the vehicle, the first roll cage displacement assembly being configured to allow for displacement of the first roll cage assembly portion with respect to the vehicle; and
a second roll cage displacement assembly coupled to the second roll cage assembly portion and the vehicle, the second roll cage displacement assembly being configured to allow for displacement of the second roll cage assembly portion with respect to the vehicle.

14. A roll cage assembly for use on a vehicle, the roll cage assembly comprising:
one or more structural components; and
at least one pivoting assembly for allowing at least a portion of the one or more structural components to pivot with respect to the vehicle.

15. The roll cage assembly of claim 14 wherein the one or more structural components form a first roll cage assembly portion and a second roll cage assembly portion.

16. The roll cage assembly of claim 15 wherein the at least one pivoting assembly includes:
a first pivoting assembly coupled to the first roll cage assembly portion and the vehicle, the first pivoting assembly being configured to allow for displacement of the first roll cage assembly portion with respect to the vehicle; and
a second pivoting assembly coupled to the second roll cage assembly portion and the vehicle, the second pivoting assembly being configured to allow for displacement of the second roll cage assembly portion with respect to the vehicle.

17. A roll cage assembly for use on an unmanned vehicle, the roll cage assembly comprising:
a first roll cage assembly portion;
a second roll cage assembly portion;
a first pivoting assembly coupled to the first roll cage assembly portion and the unmanned vehicle, the first pivoting assembly being configured to allow for displacement of the first roll cage assembly portion with respect to the unmanned vehicle; and
a second pivoting assembly coupled to the second roll cage assembly portion and the vehicle, the second pivoting assembly being configured to allow for displacement of the second roll cage assembly portion with respect to the unmanned vehicle.

18. The roll cage assembly of claim 17 further comprising:
one or more armored panel assemblies coupled to at least one of the first and second roll cage assembly portions and configured to protect the vehicle from attack.

19. The roll cage assembly of claim 18 wherein the one or more armored panel assemblies are constructed of a material chosen from the group consisting of: plate steel; Kevlar; and reactive armor material.

20. The roll cage assembly of claim 17 wherein the unmanned vehicle is a law enforcement/military unmanned vehicle.
